(19) United States
(12) Patent Application Publication
(10) Pub. No.: US 2010/0136161 A1
(43) Pub. Date: Jun. 3, 2010

(54) SWEETENER-CONTAINING ANIMAL FOOD AND ANIMAL-FOOD ADDITIVE

(76) Inventor: Hermann Roth, Eltville (DE)

Correspondence Address: K.F. ROSS P.C., 5683 RIVERDALE AVENUE, SUITE 203 BOX 900, BRONX, NY, 10471-0900, US

(21) Appl. No.: 12/594,953

(22) PCT Filed: Feb. 27, 2008
(86) PCT No.: PCT/EP2008/001539

§ 371 Date: Oct. 7, 2009

(30) Foreign Application Priority Data
Apr. 12, 2007 (AT) A 567/2007

(51) Int. Cl. A23K 1/16; A23L 1/236; A23K 1/18

(52) U.S. Cl. 426/2; 426/72; 426/636; 426/650; 426/548

(57) ABSTRACT

The invention relates to animal food containing one or more conventional animal food ingredients selected from among cereal, cereal products, proteins, amino acids, vitamins, enzymes, mineral additives, and flavors, or an animal food additive for producing such animal food. Said animal food or animal food additive contains a sweetener combination which stimulates the appetite and/or improves performance and comprises at least naringin dihydrochalcone and a saccharin.

The present invention relates to a sweetener-containing animal feed and/or animal-feed additives.

Substances for sweetening have been used successfully in animal nutrition for years, particularly when feeding young animals. The most well known substance of this type is sugar. However, sugar actually has a sweetening effect that starts only at concentrations above 3-5%. Because of this and technological restrictions, the use of synthetic sweeteners has established itself, particularly in feeding farrows. Here, this important source of sweetness is most often Na saccharine. It is characterized by high sweetening effect, i.e. the sweetening power of 1 kg of saccharine corresponds to that of approximately 300-500 kg of sugar. But saccharine has a metallic aftertaste, for which reason it is most often combined with other sweeteners in order to mask this aftertaste. Feeding saccharine exclusively can even effect a depression of feed intake at high doses because of the aftertaste.

A very widespread sweetener is neohesperidin dihydrochalcone (NHDC). Neohesperidin can be obtained from citrus fruits, preferably bitter oranges, and turned into NHDC according to known procedures. NHDC has a licorice- or menthol-like aftertaste. It has a sweetening power that is 2-4 times higher than that of saccharine. Its use in animal feed is favored by the high sweetening power in addition to the synergistic effect of the sweetening profile with saccharine. NHDC masks the metallic aftertaste of saccharine and lengthens the sweet feeling on the tongue, but because of its aftertaste and its high price, it is not used exclusively.

U.S. Pat. No. 6,251,464 describes a powder-like sweetener composition for animal feed for young animals, present in a composition that has a sweetener and a sweetener enhancer in the form or a thorough mixture of the components with an essentially even distribution of sweetener and sweetener enhancer at a constant relationship in all particles of the composition. The sweetener contained in the composition is selected from Na saccharinate or Ca saccharinate, saccharine, aspartyl phenyl alanine, acesulfame, cyclamates, steviosides and their mixtures, and the sweetener enhancer is selected from neohesperidine dihydrochalcone, thaumatin, glycerrhicine and their mixtures.

By using conventional animal feed in feeding experiments in farrow breeding that contain a combination of neohesperidine dihydrochalcone (NHDC) in combination with saccharine, it has been shown that NHDC is well in a position to mask the metallic aftertaste of saccharine so that better consumption of feed and better daily weight gain result, but the expense of the feed remains unchanged.

The present invention proposes the use of a sweetener combination that contains at least naringine DC and a saccharine for enhancing appetite and performance of productive livestock.

Naringine DC is a relatively new sweetener. Per kilogram, it has a sweetening power that corresponds to approximately 500-800 kg of sugar. It is marked by a long-lasting sweet neutral taste. It has been shown in accordance with the invention that it can cover the bitter aftertaste of saccharine without disadvantageously depressing feed intake. Naringine can be obtained from grapefruit and be turned into naringine DC according to known methods. It is known that in a series of medications (for example, cyclosporine, felodipine), resorption is improved when these are taken together with grapefruit juice. In this context it is being discussed in medical circles whether the dosage of the medications can be reduced when they are administered together with grapefruit juice.

The saccharine in the combination of sweeteners in accordance with the invention can be selected from saccharine and its alkali metal salts or earth alkali metal salts such as, for example, Na saccharine, K saccharine or Ca saccharine. Within the scope of the present invention, anhydrous forms as well as hydrates are to be understood by saccharine and/or saccharine salts.

In accordance with the invention, the appetite-enhancing and performance-enhancing combination of sweeteners can contain at least one additional sweetener that is preferably selected from stevia extracts and thaumatin. The expression “stevia extract” as used in the present invention comprises the extracts obtained from plants of the genus stevia such as, for example, stevia rebaudiana, and the glucosides contained in such extracts, particularly the diterpene glucoside of the Kauren type, which can also be present as isolated sweeteners such as, for example, stevioside, rebaudioside, dulcoside etc., as well as mixtures of sweeteners derived from stevia plants.

Stevia extracts can be obtained from plant material of stevia plants by extraction, for example, with water or ethanol. Within the framework of the present invention, raw extracts of stevia plant (material) can be used or fractions of the extracts containing an enrichment of the respectively desired substance(s) or the sweeteners isolated from the extracts. The stevia extracts that are used in accordance with the invention can be present in liquid or in solid form, for example, as a powder.

Thaumatin is a protein with high sweetening power. It can be isolated from fruits, for example, the seed vessels of the katemfe plant. As the thaumatin gene can be cloned easily and, for example, be introduced into microorganisms, the sweetener can also be produced genetically. Within the scope of the present invention, naturally occurring thaumatin, as well as genetically synthesized sweetener can be used.

In a further embodiment of the invention, an animal feed is proposed that contains a combination of sweeteners for appetite and/or performance enhancement in productive livestock, that contains at least naringine DC and a saccharine. In accordance with the invention, the combination of sweeteners contained in the animal feed can contain an additional sweetener that is preferably selected from stevia extracts and thaumatin.

The animal feed can contain all conventional animal feed components that are usual in animal husbandry. Among them are, for example, components that contain starch such as, grains and grain products; proteins; amino acids, particularly essential amino acids; vitamins; enzymes; mineral additives such as trace elements, phosphates, salts and calcium carbonate; and flavoring substances. The proteins can be of natural origin or be added as preparations. The amino acids can be industrially produced free amino acids or their chemically defined analogs (salts) or concentrates that were obtained by purification and enrichment of natural sources or by chemical synthesis or fermentation. If desired, additional additives can also be added to the animal feed such as, for example, medicinal substances.

In a further embodiment of the invention, an animal-feed additive for the production of an animal feed is proposed that contains a combination of sweetening agents for enhancing appetite and/or performance in productive livestock, where the animal-feed additive contains at least naringine DC and a saccharine. In accordance with the invention, the combination of sweetener contained in the animal-feed additive can contain an additional sweetener, preferably selected from stevia extracts and thaumatin.

In the present description, the term animal-feed additive means, for example, premixes, mineral feed or supplementary animal feed for preparing animal feed, but also exclusively a combination of sweetening agents according to the invention for enhancing appetite and/or performance. Depending on the type of animal-feed additive, in addition to a combination of sweeteners in accordance with the invention, one or more animal feed components can be contained that are selected from grains, grain products, proteins, amino acids, vitamins, enzymes, mineral additives, flavor substances etc. Medicinal substances can also be contained in the animal-feed additive.

The saccharine contained in the animal feed or in the animal-feed additive according to the invention can be selected from a saccharine and its alkali metal salts or earth alkali metal salts such as, for example Na saccharine, K saccharine or Ca saccharine where saccharine means saccharine salts, anhydrous forms, as well as hydrates.

The stevia extracts that can be contained in the animal feed or animal-feed additive in accordance with the invention are defined as specified above.

According to one feature of the invention, an animal feed or animal-feed additive can contain a saccharine in a quantity of up to 500 mg and naringine DC in a quantity of 0.1 to 1,000 mg, preferably 1 to 100 mg per kilogram of animal feed.

According to a different feature of the invention, an animal feed or an animal-feed additive can also contain a saccharine in a quantity of up to 500 mg, naringine DC in a quantity of 0.1 to 1,000 mg, preferably 1 to 100 mg, and stevia extract in a quantity of 0.1 to 100 mg, preferably 1 to 100 mg per kilogram of animal feed.

The invention also concerns the use of a combination of sweeteners for enhancing appetite and/or performance for the production of an animal feed as described above or for the production of an animal-feed additive, as described above, the combination of sweeteners containing at least naringine DC and a saccharine, as defined above. In accordance with the invention, a combination of sweeteners can be used that contains an additional sweetener that is preferably selected from stevia extracts and thaumatin as defined above.

In comparative feeding experiments, by using the conventional combination of saccharine and neohesperidin dihydrochalcone on the one hand and a combination of sweeteners according to the invention—for example—naringine DC and Na saccharine on the other, it was found that the test animals clearly prefer the animal feed containing the combination of sweeteners according to the invention, rather than the animal feeds containing the conventional combination of sweeteners. The relationship is approximately ⅔ to ⅓ in favor of the combination of sweeteners in accordance with the invention. For a person skilled in the art, this represents a surprisingly advantageous effect of the invention.

The total feed intake was smaller when using the combination of sweeteners in accordance with the invention than when using the conventional combination of sweeteners as mentioned above. In spite of that, at the end of the feeding period, the test animals had a higher weight, which represents a significantly better utilization of feed; this means that a decrease of feed intake achieves more weight per animal. The feed utilization when using an animal feed containing a combination of sweeteners according to the invention is improved by approximately 15% with respect to the combination of neohesperidine dihydrochalcone with saccharine. For an animal breeder, this represents a significant economic advantage and thus an additional advantage of the invention.

It is to be assumed that the exclusive use of naringine DC as an animal-feed additive—as the use of other sweetening substances as well—has at least an appetite-enhancing effect. The advantages in accordance with the invention are, however, not achieved with such and the costs are significantly higher than when using a combination of sweeteners.

In the following, the invention will be explained in more detail with the aid of examples of embodiments.

### EXAMPLES

The examples indicated in the following show that by using a combination of sweeteners consisting of a saccharine and naringine DC, that are perhaps used together with an additional sweetener such as, for example, a stevia extract, an increase of animal performance and/or animal feed acceptance can be achieved compared with the performance and/or animal feed acceptance when using a conventional animal feed mix with Na saccharine/neohes-peridine dihydrochalcone (NHDC) or when using a conventional animal feed without sweeteners.

### Example 1

Starting with their seventh day of life, the farrows of 14 litters (149) farrows) were offered a prestarter that contained either no sweetener (control), a sweetener based in saccharine/NHDC (comparison) or one that contained a product in accordance with the invention based in saccharine/naringine DC or based in saccharine/naringine DC/stevia extract. One week after discontinuation, the farrows were changed to a farrow-breeding feed of one of the three animal feed variants. Starting with the 22^{nd} day after discontinuation, all animals received non-supplemented feed.

The following Table 1 indicates the results.

TABLE 1

| | Phase 1: | | | |
|---|---|---|---|---|
| | 7^{th} day to 7 days | | Phase 2: | |
| | after | | 7^{th} day to 22^{nd} day | |
| | discontinuation | | after discontinuation | |
| | Feed | | Feed | |
| | intake/animal | | intake/animal | |
| | in | | in | |
| Combination of | phase 1, | DI* | phase 2, | DI* |
| sweetener | kg | g/day | kg | g/day |
| None (Control) | 1.62 | 207 | 5.06 | 2.54 |
| 150 mg saccharine + | 1.55 | 203 | 5.10 | 256 |
| .75 mg NHDC per kg | | | | |
| feed (comparison) | | | | |
| 150 mg saccharine + | 1.48 | 236 | 5.02 | 298 |
| .45 mg naringine DC + | | | | |
| 4.5 mg stevia extract | | | | |
| per kg feed | | | | |
| (Invention) | | | | |
| 150 mg saccharine + | 1.51 | 225 | 5.09 | 280 |
| 1.35 mg naringine DC | | | | |
| per kg feed | | | | |
| (Invention) | | | | |

*DI = daily [weight] increase

It was found that the animals with saccharine/naringine DC or saccharine/naringine DC/stevia extract supplement accepted feed earlier and also during the critical discontinuation phase, they showed better performance. Even after discontinuation of the feed, the animals retained their advance up to the end of breeding with respect to other groups. The average final weights were:

| | |
|---|---|
| 26.73 kg | Control |
| 26 kg | Saccharine/NHDC (comparison) |
| 27.52 kg | Naringine DC/saccharine, |
| 27.69 kg | Saccharine/naringine DC/stevia extract |

The utilization of feed was also significantly improved by the combination of sweeteners according to the invention, for example, in the case of saccharine/naringine DC/stevia extract from 0.73 to 0.61 feed units up to the 22nd day after the end of the suckling period.

The performance between the 7^{th} day after birth and the 22^{nd} day after the end of the suckling period are shown in the following Table 2.

TABLE 2

| | | | Feed used |
|---|---|---|---|
| | | | including |
| | | | suckling |
| Combination of sweetener | Weight Gain | Feed | period |
| None | 9.14 kg | 6.68 kg | .73 |
| (Control) | | | |
| Saccharine/NHDC | 9.22 kg | 6.65 kg | .72 |
| (Comparison) | | | |
| Saccharine/naringine DC/stevia | 10.73 kg | 6.50 kg | .61 |
| extract (Invention) | | | |
| Saccharine/naringine DC | 10.5 kg | 6.6 kg | .63 |
| (Invention) | | | |

It is astonishing that the animals that were fed with the feed in accordance with the invention did not consume more feed corresponding to their increased performance. Here, the early intake of feed is most likely decisive, especially also even after discontinuation, and perhaps a better utilization of nutrients, as is described in literature for some active ingredients in relation to the extracts from grapefruit products.

### Example 2

Eighty weaned farrows were evenly distributed in 4 bays, and they respectively offered two types of feed. Feed 1 contained a commercial mix of Na saccharine (150 mg/kg feed) and NHDC (0.75 mg/kg feed) as sweeteners, while feed 2 contained a mixture of Na saccharine (150 mg/kg feed), naringine DC (0.45 mg/kg feed) and stevia extract (4.5 mg/kg feed). Two automated feeders stood in each bay for free selection. In the following Table 3, the results are shown:

TABLE 3

| | | | Feed | Feed |
|---|---|---|---|---|
| | | | quantity/week/bay | quantity/week/ |
| | Starting | Feed | (kg) | bay |
| | weight | quantity/week/bay | saccharine/ | (kg |
| | (kg)/ | (kg) | naringine- | saccharine/ |
| | animal | saccharine-NHDC | DE/stevia extracts | naringine-DC |
| Week 1 | 9.32 | 35.6 | 50.3 | 50 |
| Week 2 | 9.67 | 117.1 | 135.4 | 136 |
| Week 3 | 12 | 175.2 | 293.6 | 290 |
| Week 4 | 15 | 260.9 | 347.8 | 340 |
| Week 5 | 18.9 | 321.6 | 430.9 | 432 |
| Week 6 | 23.45 | 235.9 | 276.7 | 270 |
| Total | 26.26 | 1146.3 | 1534.7 | 1518 |

It has been shown that more of the feed containing the combination of sweetener according to the invention is eaten over the entire test period than a conventional feed containing a conventional mixture of saccharine and NHDC. The mixture of the sweetening power of saccharine and naringine DC as well as the perhaps additional sweetener thus represents an important advance in the feeding of farrows.

1. An animal feed that contains one or more conventional animal feed components selected from the group consisting of grains, grain products, proteins, amino acids, vitamins, enzymes, mineral additives, and flavoring substances and a combination of sweeteners for appetite-enhancement or performance-enhancement that includes at least naringine dihydrochalcone (naringine DC) and saccharine or a salt thereof.

2. The animal feed according to claim 1 wherein the saccharine or salt thereof is present in a quantity of up to 500 mg and naringine DC in a quantity of 0.1 to 1,000 mg per kilogram of animal feed.

3. The animal feed according to claim 1 wherein the combination of sweeteners contains an additional sweetener that is selected from stevia extracts and thaumatin.

4. The animal feed according to claim 3, comprising
stevia extract as the additional sweetener.

5. The animal feed according to claim 4 wherein the saccharine or salt thereof is present in a quantity of up to 500 mg, naringine DC in a quantity of 0.1 to 1,000 mg, and stevia extract in a quantity of 0.1 to 100 mg, per kilogram of animal feed.

6. The animal feed according to claim 1 wherein the saccharine or salt thereof is saccharine, its alkali metal salts, or its alkaline earth metal salts.

7. The animal feed according to claim 6 wherein the saccharine salt is Na saccharine, K saccharine or Ca saccharine.

8-18. (canceled)

19. The animal feed according to claim 2 wherein the naringine dihydrochalcone (naringine DC) and the saccharine or salt thereof are present in a weight ratio of 1.35 to 150.

20. The animal feed according to claim 5 wherein the the saccharine or salt thereof, the naringine dihydrochalcone (naringine DC) and the stevia extract are present in a weight ratio of 150 to 0.45 to 4.5.

21. An animal feed additive that comprises a combination of sweeteners for appetite-enhancement or performance-enhancement that includes at least naringine dihydrochalcone (naringine DC) and saccharine or a salt thereof.

22. The animal feed additive according to claim 21 wherein the combination of sweeteners contains an additional sweetener that is selected from stevia extracts and thaumatin.

23. The animal feed additive according to claim 22 wherein the additional sweetener is a stevia extract.

24. The animal feed additive according to claim 21 wherein the saccharine or salt thereof is saccharine, its alkali metal salts, or its alkaline earth metal salts.

25. The animal feed additive according to claim 24 wherein the saccharine salt thereof is Na saccharine, K saccharine or Ca saccharine.

26. The animal feed additive according to claim 21 wherein the naringine dihydrochalcone (naringine DC) and the saccharine or salt thereof are present in a weight ratio of 1.35 to 150.

27. The animal feed additive according to claim 23 wherein the saccharine or salt thereof, the naringine dihydrochalcone (naringine DC) and the stevia extract are present in a weight ratio of 150 to 0.45 to 4.5.

28. The animal feed additive according to claim 21 further comprising one or more animal feed components selected from the group consisting of grains, grain products, proteins, amino acids, vitamins, enzymes, mineral additives and flavoring substances.

29. A method of improving appetite or performance in livestock which comprises the step of feeding the livestock with the animal feed according to claim 1.

30. A method of stimulating appetite or enhancing performance of livestock which comprises the step of administering to the livestock in conjunction with animal feed, an amount of the feed additive according to claim 21 effective to stimulate the appetite or enhance the performance of the livestock.

31. A method of preparing an animal feed for livestock which comprises the step of formulating the animal feed with an animal feed additive that comprises a combination of sweeteners for appetite-enhancement or performance-enhancement that includes at least naringine dihydrochalcone (naringine DC) and saccharine or a salt thereof.
